(19) United States
(12) Patent Application Publication
(10) Pub. No.: US 2025/0004751 A1
(43) Pub. Date: Jan. 2, 2025

(54) VISUAL INDICATION OF SOFTWARE UPDATE IN A CONDUCTED ELECTRICAL WEAPON

(71) Applicant: Axon Enterprise, Inc., Scottsdale, AZ (US)

(72) Inventor: Gerzain MATA, Scottsdale, AZ (US)

(21) Appl. No.: 18/756,337

(22) Filed: Jun. 27, 2024

Related U.S. Application Data
(60) Provisional application No. 63/524,558, filed on Jun. 30, 2023.

(51) Int. Cl. G06F 8/65; F41H 13/00; G06F 8/61

(52) U.S. Cl. CPC G06F 8/65; F41H 13/0025; G06F 8/61

(57) ABSTRACT

A conducted electrical weapon (“CEW”) may receive an installation package. The installation package may include software to be installed on the CEW. The installation package may include executable instructions for installing the software. The CEW may execute the instructions to being installing the software. The CEW may provide a first LED indication via an LED interface. The first LED indication may be configured to provide a visual notice that the software is being installed. The CEW may disable one or more components of the CEW. For example, the CEW may disable a light module of the CEW. Disabling the light module may also provide visual notice that the software is being installed.

### FIELD OF THE INVENTION

Embodiments of the present invention relate to providing indication of software updates in a conducted electrical weapon (“CEW”).

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1 illustrates a schematic diagram of a CEW, in accordance with various embodiments;

FIG. 2 is a block diagram of a CEW ecosystem, in accordance with various embodiments;

FIG. 3 illustrates a process flow for a method of providing indication of a software update in a CEW, in accordance with various embodiments; and

FIG. 4 is a block diagram illustrating components of a computer-based system, in accordance with various embodiments.

Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

### DETAILED DESCRIPTION

The detailed description of exemplary embodiments herein makes reference to the accompanying drawings, which show exemplary embodiments by way of illustration. While these embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, coupled, connected, or the like may include permanent, removable, temporary, partial, full, and/or any other possible attachment option. Surface shading lines may be used throughout the figures to denote different parts but not necessarily to denote the same or different materials.

Systems, methods, and apparatuses may be used to interfere with voluntary locomotion (e.g., walking, running, moving, etc.) of a target. For example, a conducted electrical weapon (e.g., “CEW”) may be used to deliver a current (e.g., stimulus signal, pulses of current, pulses of charge, etc.) through tissue of a human or animal target. Although typically referred to as a conducted electrical weapon, as described herein a “CEW” may refer to an energy weapon, a conducted electrical weapon, a conducted energy weapon, an electronic control device, and/or any other similar device or apparatus configured to provide a stimulus signal through one or more deployed projectiles (e.g., electrodes), such as those offered by Axon Enterprise, Inc. under its famous TASER® trademark.

Principles and features of the present disclosure may be applied to other less-lethal and non-lethal weapons and devices, including, for example, electronic devices configured to deploy projectiles towards a target (e.g., projectile launchers), electronic devices configured for training purposes (e.g., to imitate less-lethal and/or non-lethal weapons), electronic devices configured for virtual reality (e.g., to imitate real-world use of less-lethal and/or non-lethal weapons), and/or the like.

For example, in some embodiments a CEW may comprise a projectile launcher. A projectile launcher may be configured to launch any suitable type of projectile. A projectile may include any object, payload, capsule, and/or the like configured to be deployed from a projectile launcher. For example, and in accordance with various embodiments, a projectile may comprise a non-lethal projectile or a less-lethal projectile. In that regard a projectile may comprise or be configured to deploy a dart, a paintball, a rubber projectile (e.g., a rubber bullet), CEW electrode, a modular conducted electrical weapon (MCEW) electrode or payload, an entangling projectile configured to entangle a target (e.g., a tether-based entangling projectile, a net, etc.), a scent-based projectile, a liquid-based projectile, a gas-based projectile, pepper spray or a pepper spray projectile (e.g., oleoresin capsicum, OC spray), tear gas or a tear gas cannister or projectile (e.g., 2-chlorobenzalmalononitrile, CS spray), and/or any other non-lethal or less-lethal projectile.

In some embodiments, a projectile may be configured to deliver an inhibitory substance (e.g., to at least partially inhibit a target). In some embodiments, a projectile may be configured to deliver a marking substance (e.g., to mark or designate a target).

A CEW may be configured to deliver a stimulus signal to a target. A stimulus signal carries a charge into target tissue. The stimulus signal may interfere with voluntary locomotion of the target. The stimulus signal may cause pain. The pain may also function to encourage the target to stop moving. The stimulus signal may cause skeletal muscles of the target to become stiff (e.g., lock up, freeze, etc.). The stiffening of the muscles in response to a stimulus signal may be referred to as neuromuscular incapacitation (“NMI”). NMI disrupts voluntary control of the muscles of the target. The inability of the target to control its muscles interferes with locomotion by the target.

A stimulus signal may be delivered through the target via terminals coupled to the CEW. Delivery via terminals may be referred to as a local delivery (e.g., a local stun). During local delivery, the terminals are brought close to the target by positioning the CEW proximate to the target. The stimulus signal is delivered through the target's tissue via the terminals. To provide local delivery, the user of the CEW is generally within arm's reach of the target and brings the terminals of the CEW into contact with or proximate to the target.

A stimulus signal may be delivered through the target via one or more (typically at least two) wire-tethered electrodes. Delivery via wire-tethered electrodes may be referred to as a remote delivery (e.g., a remote stun). During a remote delivery, the CEW may be separated from the target up to the length (e.g., 15 feet, 20 feet, 30 feet, etc.) of the wire tether. The CEW launches the electrodes towards the target. As the electrodes travel toward the target, their respective wire tethers deploy behind the electrodes. The wire tether electrically couples the CEW to the electrode. The electrode may electrically couple to the target thereby coupling the CEW to the target. In response to the electrodes connecting with, impacting on, or being positioned proximate to the target's tissue, the current may be provided through the target via the electrodes (e.g., a circuit is formed through the first tether and first electrode, the target's tissue, and the second tether and second electrode).

Terminals or electrodes that contact or are proximate to the target's tissue deliver the stimulus signal through the target. Contact of a terminal or electrode with the target's tissue establishes an electrical coupling (e.g., circuit) with the target's tissue. Electrodes may include a spear that may pierce the target's tissue to contact the target. A terminal or electrode that is proximate to the target's tissue may use ionization to establish an electrical coupling with the target's tissue. Ionization may also be referred to as arcing.

In use (e.g., during deployment), a terminal or electrode may be separated from the target's tissue by the target's clothing or a gap of air. In various embodiments, a signal generator of the CEW may provide the stimulus signal (e.g., current, pulses of current, etc.) at a high voltage (e.g., in the range of 40,000 to 100,000 volts) to ionize the air in the clothing or the air in the gap that separates the terminal or electrode from the target's tissue. Ionizing the air establishes a low impedance ionization path from the terminal or electrode to the target's tissue that may be used to deliver the stimulus signal into the target's tissue via the ionization path. The ionization path persists (e.g., remains in existence, lasts, etc.) as long as the current of a pulse of the stimulus signal is provided via the ionization path. When the current ceases or is reduced below a threshold (e.g., amperage, voltage), the ionization path collapses (e.g., ceases to exist) and the terminal or electrode is no longer electrically coupled to the target's tissue. Lacking the ionization path, the impedance between the terminal or electrode and target tissue is high. A high voltage in the range of about 50,000 volts can ionize air in a gap of up to about one inch.

A CEW may provide a stimulus signal as a series of current pulses. Each current pulse may include a high voltage portion (e.g., 40,000-100,000 volts) and a low voltage portion (e.g., 500-6,000 volts). The high voltage portion of a pulse of a stimulus signal may ionize air in a gap between an electrode or terminal and a target to electrically couple the electrode or terminal to the target. In response to the electrode or terminal being electrically coupled to the target, the low voltage portion of the pulse delivers an amount of charge into the target's tissue via the ionization path. In response to the electrode or terminal being electrically coupled to the target by contact (e.g., touching, spear embedded into tissue, etc.), the high portion of the pulse and the low portion of the pulse both deliver charge to the target's tissue. Generally, the low voltage portion of the pulse delivers a majority of the charge of the pulse into the target's tissue. In various embodiments, the high voltage portion of a pulse of the stimulus signal may be referred to as the spark or ionization portion. The low voltage portion of a pulse may be referred to as the muscle portion.

In various embodiments, a signal generator of the CEW may provide the stimulus signal (e.g., current, pulses of current, etc.) at only a low voltage (e.g., less than 2,000 volts). The low voltage stimulus signal may not ionize the air in the clothing or the air in the gap that separates the terminal or electrode from the target's tissue. A CEW having a signal generator providing stimulus signals at only a low voltage (e.g., a low voltage signal generator) may require deployed electrodes to be electrically coupled to the target by contact (e.g., touching, spear embedded into tissue, etc.).

In various embodiments, a CEW may include at least two terminals at the face of the CEW. A CEW may include two terminals for each bay that accepts a deployment unit (e.g., cartridge). The terminals are spaced apart from each other. In response to the electrodes of the deployment unit in the bay having not been deployed, the high voltage impressed across the terminals will result in ionization of the air between the terminals. The arc between the terminals may be visible to the naked eye. In response to a launched electrode not electrically coupling to a target, the current that would have been provided via the electrodes may arc across the face of the CEW via the terminals.

The likelihood that the stimulus signal will cause NMI increases when the electrodes that deliver the stimulus signal are spaced apart at least 6 inches (15.24 centimeters) so that the current from the stimulus signal flows through the 6 or more inches of the target's tissue. In various embodiments, the electrodes preferably should be spaced apart at least 12 inches (30.48 centimeters) on the target. Because the terminals on a CEW are typically less than 6 inches apart, a stimulus signal delivered through the target's tissue via terminals likely will not cause NMI, only pain.

A series of pulses may include two or more pulses separated in time. Each pulse delivers an amount of charge into the target's tissue. In response to the electrodes being appropriately spaced (as discussed above), the likelihood of inducing NMI increases as each pulse delivers an amount of charge in the range of 55 microcoulombs to 71 microcoulombs per pulse. The likelihood of inducing NMI increases when the rate of pulse delivery (e.g., rate, pulse rate, repetition rate, etc.) is between 11 pulses per second (“pps”) and 50 pps. Pulses delivered at a higher rate may provide less charge per pulse to induce NMI. Pulses that deliver more charge per pulse may be delivered at a lesser rate to induce NMI. In various embodiments, a CEW may be hand-held and use batteries to provide the pulses of the stimulus signal. In response to the amount of charge per pulse being high and the pulse rate being high, the CEW may use more energy than is needed to induce NMI. Using more energy than is needed depletes batteries more quickly.

Empirical testing has shown that the power of the battery may be conserved with a high likelihood of causing NMI in response to the pulse rate being less than 44 pps and the charge per pulse being about 63 microcoulombs. Empirical testing has shown that a pulse rate of 22 pps and 63 microcoulombs per pulse via a pair of electrodes will induce NMI when the electrode spacing is about 12 inches (30.48 centimeters).

In various embodiments, a CEW may include a handle and one or more deployment units. The handle may include one or more bays for receiving the deployment units. Each deployment unit may be removably positioned in (e.g., inserted into, coupled to, etc.) a bay. Each deployment unit may releasably electrically, electronically, and/or mechanically couple to a bay. In various embodiments, a CEW may include a bay configured to receive a magazine comprising one or more electrodes. A deployment (e.g., launch) of the CEW may launch one or more electrodes toward a target to remotely deliver the stimulus signal through the target.

In various embodiments, a deployment unit may include two or more electrodes that are launched at the same time. In various embodiments, a deployment unit may include two or more electrodes that may be launched at separate times. Launching the electrodes may be referred to as activating (e.g., firing) a deployment unit. After use (e.g., activation, firing), a deployment unit may be removed from the bay and replaced with an unused (e.g., not fired, not activated) deployment unit to permit launch of additional electrodes.

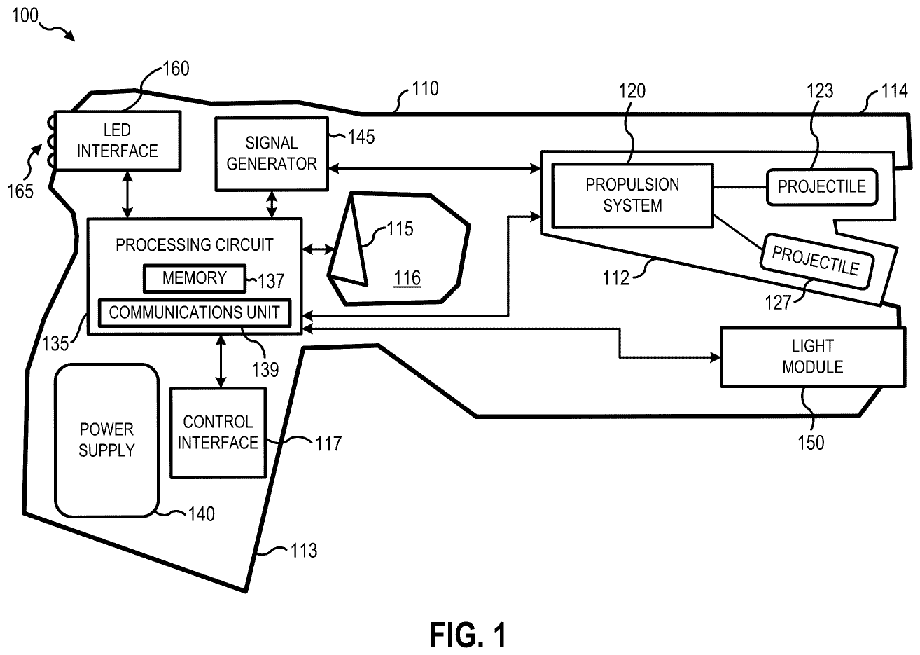

In various embodiments, and with reference to FIG. 1, a CEW 100 is disclosed. CEW 100 may be similar to, or have similar aspects and/or components with, any other CEW or projectile launcher discussed herein. It should be understood by one skilled in the art that FIG. 1 is a schematic representation of CEW 100, and unless specified otherwise, one or more of the components of CEW 100 may be located in any suitable position within, or external to, handle 110. CEW 100 may comprise a handle 110 and one or more deployment units 112.

Handle 110 may be configured to house various components of CEW 100 configured to enable deployment of the deployment units 112, provide an electrical current to the deployment units 112, and otherwise aid in the operation of CEW 100, as discussed further herein. Although depicted as a firearm in FIG. 1, handle 110 may comprise any suitable shape and/or size. Handle 110 may comprise a handle end 113 opposite a deployment end 114. Deployment end 114 may be configured, and sized and shaped, to receive one or more deployment units 112. Handle end 113 may be sized and shaped to be held in a hand of a user. For example, handle end 113 may be shaped as a handle to enable hand-operation of the CEW by the user. In various embodiments, handle end 113 may also comprise contours shaped to fit the hand of a user, for example, an ergonomic grip. Handle end 113 may include a surface coating, such as, for example, a non-slip surface, a grip pad, a rubber texture, and/or the like. As a further example, handle end 113 may be wrapped in leather, a colored print, and/or any other suitable material, as desired.

In various embodiments, handle 110 may comprise various mechanical, electronic, and electrical components configured to aid in performing the functions of CEW 100. For example, handle 110 may comprise one or more triggers 115, control interfaces 117, processing circuits 135, power supplies 140, signal generators 145, light modules 150, LED interfaces 160, and/or the like. Handle 110 may include a guard 116. Guard 116 may define an opening formed in handle 110. Guard 116 may be located on a center region of handle 110 (e.g., as depicted in FIG. 1), and/or in any other suitable location on handle 110. Trigger 115 may be disposed within guard 116. Guard 116 may be configured to protect trigger 115 from unintentional physical contact (e.g., an unintentional activation of trigger 115). Guard 116 may surround trigger 115 within handle 110.

In various embodiments, trigger 115 be coupled to an outer surface of handle 110, and may be configured to move, slide, rotate, otherwise become physically depressed upon application of the physical contact. For example, trigger 115 may be actuated by physical contact applied to trigger 115 from within guard 116. Trigger 115 may comprise a mechanical or electromechanical switch, button, trigger, or the like. For example, trigger 115 may comprise a switch, a pushbutton, and/or any other suitable type of trigger. Trigger 115 may be mechanically and/or electronically coupled to processing circuit 135. In response to trigger 115 being activated (e.g., depressed, pushed, etc. by the user), processing circuit 135 may enable deployment of one or more deployment units 112 from CEW 100, as discussed further herein.

In various embodiments, power supply 140 may be configured to provide power to various components of CEW 100. For example, power supply 140 may provide energy for operating the electronic and/or electrical components (e.g., parts, subsystems, circuits) of CEW 100 and/or one or more deployment units 112. Power supply 140 may provide electrical power. Providing electrical power may include providing a current at a voltage. Power supply 140 may be electrically coupled to processing circuit 135, signal generator 145, light module 150, and/or LED interface 160. In various embodiments, in response to control interface 117 comprising electronic properties and/or components, power supply 140 may be electrically coupled to control interface 117. In various embodiments, in response to trigger 115 comprising electronic properties or components, power supply 140 may be electrically coupled to trigger 115. Power supply 140 may provide an electrical current at a voltage. Electrical power from power supply 140 may be provided as a direct current (“DC”). Electrical power from power supply 140 may be provided as an alternating current (“AC”). Power supply 140 may include a battery. The energy of power supply 140 may be renewable or exhaustible, and/or replaceable. For example, power supply 140 may comprise one or more rechargeable or disposable batteries. In various embodiments, the energy from power supply 140 may be converted from one form (e.g., electrical, magnetic, thermal) to another form to perform the functions of a system.

Power supply 140 may provide energy for performing the functions of CEW 100. For example, power supply 140 may provide the electrical current to signal generator 145 that is provided through a target to impede locomotion of the target (e.g., via deployment unit 112). Power supply 140 may provide the energy for a stimulus signal. Power supply 140 may provide the energy for other signals, including an ignition signal and/or an integration signal, as discussed further herein.

In various embodiments, processing circuit 135 may comprise any circuitry, electrical components, electronic components, software, and/or the like configured to perform various operations and functions discussed herein. For example, processing circuit 135 may comprise a processing circuit, a processor, a digital signal processor, a microcontroller, a microprocessor, an application specific integrated circuit (ASIC), a programmable logic device, logic circuitry, state machines, MEMS devices, signal conditioning circuitry, communication circuitry, a computer, a computer-based system, a radio, a network appliance, a data bus, an address bus, and/or any combination thereof. In various embodiments, processing circuit 135 may include passive electronic devices (e.g., resistors, capacitors, inductors, etc.) and/or active electronic devices (e.g., op amps, comparators, analog-to-digital converters, digital-to-analog converters, programmable logic, SRCs, transistors, etc.). In various embodiments, processing circuit 135 may include data buses, output ports, input ports, timers, memory, arithmetic units, and/or the like.

In various embodiments, processing circuit 135 may include signal conditioning circuitry. Signal conditioning circuitry may include level shifters to change (e.g., increase, decrease) the magnitude of a voltage (e.g., of a signal) before receipt by processing circuit 135 or to shift the magnitude of a voltage provided by processing circuit 135.

In various embodiments, processing circuit 135 may be configured to control and/or coordinate operation of some or all aspects of CEW 100. For example, processing circuit 135 may comprise (or be in communication with) a memory 137 configured to store data, programs, software, firmware, and/or instructions. Memory 137 may comprise any suitable type of memory, memory unit, database, and/or the like. In some embodiments, memory 137 may comprise a tangible, non-transitory computer-readable memory. Instructions stored on the tangible non-transitory memory may allow processing circuit 135 to perform various operations, functions, and/or steps, as described herein.

The term “non-transitory” is to be understood to remove only propagating transitory signals per se from the claim scope and does not relinquish rights to all standard computer-readable media that are not only propagating transitory signals per se. Stated another way, the meaning of the terms “non-transitory computer-readable memory” and “non-transitory computer-readable storage medium” should be construed to exclude only those types of transitory computer-readable media which were found in In re Nuijten to fall outside the scope of patentable subject matter under 35 U.S.C. § 101.

In various embodiments, memory 137 may comprise any hardware, software, and/or database component capable of storing and maintaining data. For example, memory 137 may comprise a database, data structure, memory component, or the like. Memory 137 may comprise any suitable non-transitory memory known in the art, such as, an internal memory (e.g., random access memory (RAM), read-only memory (ROM), solid state drive (SSD), etc.), removable memory (e.g., an SD card, an xD card, a CompactFlash card, etc.), or the like.

Processing circuit 135 may be configured to provide and/or receive electrical signals whether digital and/or analog in form. Processing circuit 135 may provide and/or receive digital information via a data bus using any protocol. Processing circuit 135 may receive information, manipulate the received information, and provide the manipulated information. Processing circuit 135 may store information and retrieve stored information. Information received, stored, and/or manipulated by processing circuit 135 may be used to perform a function, control a function, and/or to perform an operation or execute a stored program.

Processing circuit 135 may control the operation and/or function of other circuits and/or components of CEW 100. Processing circuit 135 may receive status information regarding the operation of other components, perform calculations with respect to the status information, and provide commands (e.g., instructions) to one or more other components. Processing circuit 135 may command another component to start operation, continue operation, alter operation, suspend operation, cease operation, or the like. Commands and/or status may be communicated between processing circuit 135 and other circuits and/or components via any type of bus (e.g., SPI bus) including any type of data/address bus.

In various embodiments, processing circuit 135 may comprise or be in electronic communication with a communications unit 139. Communications unit 139 may be similar to, or comprise similar components with, any other communications unit, short-range communications unit, long-range communications unit, or the like disclosed here. Communications unit 139 may enable electronic communications between devices and systems. Communications unit 139 may enable communications over a network. For example, communications unit 139 may include a modem, a network interface (such as an Ethernet card), a communications port, a serial bus, an outlet, and/or the like. Data may be transferred via communications unit 139 in the form of signals which may be electronic, electromagnetic, optical, and/or other signals capable of being transmitted or received by a communications unit. Communications unit 139 may be configured to communicate via any wired protocol, wireless protocol, or other protocol capable of transmitting information via a wired or wireless connection. In various embodiments, communications unit 139 may be configured to enable wired communications between devices. In various embodiments, communications unit 139 may be configured to enable short-range communications between devices. In various embodiments, communications unit 139 may be configured to enable long-range communications between devices or systems. In various embodiments, communications unit 139 may be configured to enable both short-range communications and long-range communications. In various embodiments, communications unit 139 may be configured to enable wired communications, short-range communications, and/or long-range communications.

Processing circuit 135 may be electrically and/or electronically coupled to deployment unit 112. Processing circuit 135 may be configured to determine one or more deployment unit characteristics associated with deployment unit 112. A deployment unit characteristic may include data indicating various characteristics of the deployment unit. A deployment unit characteristic may include a deployment unit type, a projectile type, a projectile position, a deployment instruction, and/or any other suitable or desired information relating to a deployment unit, a projectile, the CEW, or deployment of projectiles from the deployment unit.

In various embodiments, processing circuit 135 may be mechanically and/or electronically coupled to trigger 115. In various embodiments, processing circuit 135 may be electrically coupled to a switch or other electrical component associated with or activated by trigger 115. Processing circuit 135 may be configured to detect an activation, actuation, depression, input, etc. (collectively, an “activation event”) of trigger 115. In response to detecting the activation event, processing circuit 135 may be configured to perform various operations and/or functions, as discussed further herein. Processing circuit 135 may also include a sensor (e.g., a trigger sensor) attached to or activated by trigger 115 and configured to detect or receive activation of an activation event of trigger 115. The sensor may comprise any suitable sensor, such as a mechanical and/or electronic sensor capable of detecting or receiving an activation event in trigger 115 and reporting the activation event to processing circuit 135.

In various embodiments, processing circuit 135 may be mechanically and/or electronically coupled to control interface 117. In various embodiments, processing circuit 135 may be electrically coupled to a switch or other electrical component associated with or activated by control interface 117. Processing circuit 135 may be configured to detect or receive an activation, actuation, depression, input, signal, communication, etc. (collectively, a “control event”) of control interface 117. In response to detecting or receiving the control event, processing circuit 135 may be configured to perform various operations and/or functions, as discussed further herein. Processing circuit 135 may also include a sensor (e.g., a control sensor) attached to or activated by control interface 117 and configured to detect or receive activation of a control event of control interface 117. The sensor may comprise any suitable sensor, such as a mechanical and/or electronic sensor capable of detecting or receiving a control event in control interface 117 and reporting the control event to processing circuit 135.

In various embodiments, processing circuit 135 may be electrically and/or electronically coupled to power supply 140. Processing circuit 135 may receive power from power supply 140. The power received from power supply 140 may be used by processing circuit 135 to receive signals, process signals, and transmit signals to various other components in CEW 100. Processing circuit 135 may use power from power supply 140 to detect an activation event of trigger 115, a control event of control interface 117, or the like, and generate one or more control signals in response to the detected events. The control signal may be based on the control event and the activation event. The control signal may be an electrical signal.

In various embodiments, processing circuit 135 may be electrically and/or electronically coupled to signal generator 145. Processing circuit 135 may be configured to transmit or provide control signals to signal generator 145 in response to detecting an activation event of trigger 115. Multiple control signals may be provided from processing circuit 135 to signal generator 145 in series. In response to receiving the control signal, signal generator 145 may be configured to perform various functions and/or operations, as discussed further herein.

In various embodiments, signal generator 145 may be configured to receive one or more control signals from processing circuit 135. Signal generator 145 may provide an ignition signal to deployment unit 112 based on the control signals. Signal generator 145 may be electrically and/or electronically coupled to processing circuit 135 and/or deployment unit 112. Signal generator 145 may be electrically coupled to power supply 140. Signal generator 145 may use power received from power supply 140 to generate an ignition signal. For example, signal generator 145 may receive an electrical signal from power supply 140 that has first current and voltage values. Signal generator 145 may transform the electrical signal into an ignition signal having second current and voltage values. The transformed second current and/or the transformed second voltage values may be different from the first current and/or voltage values. The transformed second current and/or the transformed second voltage values may be the same as the first current and/or voltage values. Signal generator 145 may temporarily store power from power supply 140 and rely on the stored power entirely or in part to provide the ignition signal. Signal generator 145 may also rely on received power from power supply 140 entirely or in part to provide the ignition signal, without needing to temporarily store power.

In various embodiments, signal generator 145 may include circuits for receiving electrical energy and for providing the stimulus signal. Electrical/electronic circuits (e.g., components) of signal generator 145 may include capacitors, resistors, inductors, spark gaps, transformers, silicon controlled rectifiers (“SCRs”), analog-to-digital converters, and/or the like.

Signal generator 145 may be controlled entirely or in part by processing circuit 135. In various embodiments, signal generator 145 and processing circuit 135 may be separate components (e.g., physically distinct and/or logically discrete). Signal generator 145 and processing circuit 135 may be a single component. For example, a control circuit within handle 110 may at least include signal generator 145 and processing circuit 135. The control circuit may also include other components and/or arrangements, including those that further integrate corresponding function of these elements into a single component or circuit, as well as those that further separate certain functions into separate components or circuits.

Signal generator 145 may be controlled by the control signals to generate an ignition signal having a predetermined current value or values. For example, signal generator 145 may include a current source. The control signal may be received by signal generator 145 to activate the current source at a current value of the current source. An additional control signal may be received to decrease a current of the current source. For example, signal generator 145 may include a pulse width modification circuit coupled between a current source and an output of the control circuit. A second control signal may be received by signal generator 145 to activate the pulse width modification circuit, thereby decreasing a non-zero period of a signal generated by the current source and an overall current of an ignition signal subsequently output by the control circuit. The pulse width modification circuit may be separate from a circuit of the current source or, alternatively, integrated within a circuit of the current source. Various other forms of signal generators 145 may alternatively or additionally be employed, including those that apply a voltage over one or more different resistances to generate signals with different currents.

In various embodiments, signal generator 145 may include a high-voltage module configured to deliver an electrical current having a high voltage.

In various embodiments, signal generator 145 may include a low-voltage module configured to deliver an electrical current having a lower voltage, such as, for example, 2,000 volts.

Responsive to receipt of a signal indicating activation of trigger 115 (e.g., an activation event), a control circuit provides an ignition signal to deployment unit 112. For example, signal generator 145 may provide an electrical signal as an ignition signal to deployment unit 112 in response to receiving a control signal from processing circuit 135. In various embodiments, the ignition signal may be separate and distinct from a stimulus signal. For example, a stimulus signal in CEW 100 may be provided to a different circuit within deployment unit 112, relative to a circuit to which an ignition signal is provided. Signal generator 145 may be configured to generate a stimulus signal. In various embodiments, a second, separate signal generator, component, or circuit (not shown) within handle 110 may be configured to generate the stimulus signal. Signal generator 145 may also provide a ground signal path for deployment unit 112, thereby completing a circuit for an electrical signal provided to deployment unit 112 by signal generator 145. The ground signal path may also be provided to deployment unit 112 by other elements in handle 110, including power supply 140.

In various embodiments, power supply 140 may comprise an electrical circuit (e.g., a power supply electrical circuit, a power supply circuit, etc.) defining an electrical coupling between processing circuit 135 and power supply 140. For example, the electrical circuit may comprise an electrical path (e.g., a conductive path), one or more switches controlling the electrical circuit, and/or any other suitable or desired electrical circuit components. The electrical circuit may be configured to provide energy (e.g., electricity) from power supply 140 to processing circuit 135. In some embodiments, the electrical circuit may also be configured to provide energy from power supply 140 to one or more other components of CEW 100, such as signal generator 145. Processing circuit 135 may be in electrical communication with one or more components of the electrical circuit.

In various embodiments, trigger 115 may comprise an electrical circuit (e.g., a trigger electrical circuit, a trigger circuit, etc.) defining an electrical coupling between processing circuit 135 and trigger 115. For example, the electrical circuit may comprise an electrical path (e.g., a conductive path), one or more switches controlling the electrical circuit, and/or any other suitable or desired electrical circuit components. The electrical circuit may be configured to allow trigger 115 to provide trigger signals to processing circuit 135. The electrical circuit may be configured to allow processing circuit 135 to detect trigger signals from trigger 115. Processing circuit 135 may be in electrical communication with one or more components of the electrical circuit.

In various embodiments, signal generator 145 may comprise one or more electrical circuits (e.g., signal generator electrical circuits, signal generator circuits, etc.) defining electrical couplings between signal generator 145 and one or more components of CEW 100.

For example, signal generator 145 may comprise a first electrical circuit (e.g., a first signal generator circuit, a signal generator input circuit, a charging circuit, etc.) defining an electrical coupling between power supply 140 and signal generator 145. The first electrical circuit may comprise an electrical path (e.g., a conductive path), one or more switches controlling the first electrical circuit, and/or any other suitable or desired electrical circuit components. The first electrical circuit may be configured to provide energy (e.g., electricity) from power supply 140 to signal generator 145. In some embodiments, the first electrical circuit may comprise one or more capacitors configured to store (e.g., accumulate) the energy received from power supply 140. In some embodiments, the first electrical circuit may comprise one or more switches and/or other suitable or desired electrical circuit components configured to control the provision of energy from power supply 140 to the one or more capacitors.

As a further example, signal generator 145 may comprise a second electrical circuit (e.g., a second signal generator circuit, a signal generator output circuit, a discharging circuit, etc.) defining an electrical coupling between signal generator 145 and one or more electrical contacts proximate a bay of handle 110. The second electrical circuit may be different from the first electrical circuit. The second electrical circuit and the first electrical circuit may share one or more electrical components. The second electrical circuit may comprise an electrical path (e.g., a conductive path), one or more switches controlling the electrical circuit, and/or any other suitable or desired electrical circuit components. The second electrical circuit may be configured to provide energy (e.g., electricity) from signal generator 145 to the one or more electrical contacts proximate the bay of handle 110. For example, the second electrical circuit may be configured to provide one or more stimulus signals from signal generator 145 to deployment unit 112 via electrical contacts coupling handle 110 to deployment unit 112. As a further example, the second electrical circuit may be configured to provide one or more electrical signals from signal generator 145 to one or more exposed terminals on deployment end 114. The exposed terminals may be configured to provide a local delivery (e.g., a local stun) to a target. In some embodiments, the second electrical circuit may comprise one or more capacitors configured to store (e.g., accumulate) the energy received from power supply 140 and discharge the stored energy to provide an electrical signal and/or stimulus signal. In some embodiments, the second electrical circuit may comprise one or more switches and/or other suitable or desired electrical circuit components configured to control the provision of energy from the one or more capacitors. Processing circuit 135 may be in electrical communication with one or more components of the second electrical circuit.

In various embodiments, a bay of handle 110 may be configured to receive one or more deployment units. The bay may comprise an opening in deployment end 114 sized and shaped to receive one or more deployment units. The bay may include one or more mechanical features configured to removably couple one or more deployment units within the bay. The bay may be configured to receive a single deployment unit, two deployment units, or any other number of deployment units.

In various embodiments, a deployment unit 112 may comprise a propulsion system 120 and a plurality of projectiles, such as, for example, a first projectile 123 and a second projectile 127. Deployment unit 112 may comprise any suitable or desired number of projectiles, such as, for example two projectiles, three projectiles, ten projectiles, and/or any other desired number of projectiles.

In various embodiments, propulsion system 120 may be coupled to, or in communication with, each projectile in deployment unit 112. In various embodiments, deployment unit 112 may comprise a plurality of propulsion systems 120, with each propulsion system 120 coupled to, or in communication with, one or more projectiles. Propulsion system 120 may comprise any device, propellant (e.g., air, gas, etc.), primer, or the like capable of providing a propulsion force in deployment unit 112. The propulsion force may include an increase in pressure caused by rapidly expanding gas within an area or chamber. The propulsion force may be applied to projectiles 123, 127 in deployment unit 112 to cause the deployment of projectiles 123, 127. Propulsion system 120 may provide the propulsion force in response to deployment unit 112 receiving the ignition signal.

In various embodiments, the propulsion force may be directly applied to one or more projectiles 123, 127. For example, the propulsion force may be provided directly to first projectile 123 or second projectile 127. Propulsion system 120 may be in fluid communication with projectiles 123, 127 to provide the propulsion force. For example, the propulsion force from propulsion system 120 may travel within a housing or channel of deployment unit 112 to one or more projectiles 123, 127. The propulsion force may travel via a manifold in deployment unit 112.

In various embodiments, the propulsion force may be provided indirectly to first projectile 123 and/or second projectile 127. For example, the propulsion force may be provided to a secondary source of propellant within propulsion system 120. The propulsion force may launch the secondary source of propellant within propulsion system 120, causing the secondary source of propellant to release propellent. A force associated with the released propellant may in turn provide a force to one or more projectiles 123, 127. A force generated by a secondary source of propellent may cause projectiles 123, 127 to be deployed from the deployment unit 112 and CEW 100.

In various embodiments, each projectile 123, 127 may comprise any suitable type of projectile. For example, one or more projectiles may be or include an electrode (e.g., an electrode dart), an entangling projectile (e.g., a tether-based entangling projectile, a net, etc.), a payload projectile (e.g., comprising a liquid or gas substance), or the like. A projectile may include a spear portion, designed to pierce or attach proximate a tissue of a target in order to provide a conductive electrical path between the electrode and the tissue, as previously discussed herein. For example, projectiles 123, 127 may each include a respective electrode. Projectiles 123, 127 may be deployed from deployment unit 112 at the same time or substantially the same time. Projectiles 123, 127 may be launched by a same propulsion force from a common propulsion system 120. Projectiles 123, 127 may also be launched by one or more propulsion forces received from one or more propulsion systems 120. Deployment unit 112 may include an internal manifold configured to transfer a propulsion force from propulsion system 120 to one or more projectiles 123, 127.

In various embodiments, signal generator 145 may be in electrical series with deployment unit and each projectile 123, 127. For example, signal generator 145 may be in electrical series with one or more electrical contacts (e.g., a handle contact, a handle electrical contact, etc.) disposed with the bay of handle 110. The electrical contact may be at least partially exposed within the bay. In response to deployment unit 112 being inserted within the bay, the electrical contact may engage (e.g., electrically couple to) one or more electrical contacts or features of deployment unit 112 (e.g., a deployment unit contact, a deployment unit electrical contact, etc.). Propulsion system 120 may be in electrical series with the one or more electrical contacts or features of deployment unit 112. Each projectile 123, 127 may be in electrical series with the one or more electrical contacts or features of deployment unit 112.

Signal generator 145 may be configured to provide one or more electrical signals to deployment unit 112 via the one or more electrical contacts. For example, signal generator 145 and/or processing circuit 135 may control provision of electrical signals to deployment unit 112, via the electrical contact. Signal generator 145 and/or processing circuit 135 may control provision of electrical signals by enabling and/or disabling an electrical connection. The electrical connection may define the electrical coupling between signal generator 145 and the electrical contact. Signal generator 145 and/or processing circuit 135 may enable and/or disable the electrical connection using any suitable technique or process, such as, for example, by selectively providing electrical signals, opening and/or closing circuits or switches, and/or the like. In some embodiments, providing an electrical signal may include providing a low voltage detection signal, an ignition signal, a stimulus signal, and/or the like.

In various embodiments, control interface 117 of CEW 100 may comprise, or be similar to, any control interface disclosed herein. In various embodiments, control interface 117 may be configured to control selection of firing modes in CEW 100. Controlling selection of firing modes in CEW 100 may include disabling firing of CEW 100 (e.g., a safety mode, etc.), enabling firing of CEW 100 (e.g., an active mode, a firing mode, an escalation mode, etc.), controlling deployment of a projectile, and/or similar operations, as discussed further herein. In various embodiments, control interface 117 may also be configured to perform (or cause performance of) one or more operations that do not include the selection of firing modes. For example, control interface 117 may be configured to enable the selection of operating modes of CEW 100, selection of options within an operating mode of CEW 100, or similar selection or scrolling operations, as discussed further herein.

Control interface 117 may be located in any suitable location on or in handle 110. For example, control interface 117 may be coupled to an outer surface of handle 110. Control interface 117 may be coupled to an outer surface of handle 110 proximate trigger 115 and/or a trigger guard of handle 110. Control interface 117 may be electrically, mechanically, and/or electronically coupled to processing circuit 135. In various embodiments, in response to control interface 117 comprising electronic properties or components, control interface 117 may be electrically coupled to power supply 140. Control interface 117 may receive power (e.g., electrical current) from power supply 140 to power the electronic properties or components.

Control interface 117 may be electronically or mechanically coupled to trigger 115. For example, and as discussed further herein, control interface 117 may function as a safety mechanism. In response to control interface 117 being set to a “safety mode,” CEW 100 may be unable to launch electrodes from deployment unit 112. For example, control interface 117 may provide a signal (e.g., a control signal) to processing circuit 135 instructing processing circuit 135 to disable deployment of electrodes from deployment unit 112. As a further example, control interface 117 may electronically or mechanically prohibit trigger 115 from activating (e.g., prevent or disable a user from depressing trigger 115, prevent trigger 115 from launching (or causing launch of) a projectile, etc.).

Control interface 117 may comprise any suitable electronic or mechanical component capable of enabling selection of firing modes. For example, control interface 117 may comprise a fire mode selector switch, a safety switch, a safety catch, a rotating switch, a selection switch, a selective firing mechanism, and/or any other suitable mechanical control. As a further example, control interface 117 may comprise a slide, such as a handgun slide, a reciprocating slide, or the like. As a further example, control interface 117 may comprise a touch screen, user interface or display, or similar electronic visual component.

The safety mode may be configured to prohibit deployment of a projectile from deployment unit 112. For example, in response to a user selecting the safety mode, control interface 117 may transmit a safety mode instruction to processing circuit 135. In response to receiving the safety mode instruction, processing circuit 135 may prohibit deployment of a projectile from deployment unit 112. Processing circuit 135 may prohibit deployment until a further instruction is received from control interface 117 (e.g., a firing mode instruction). As previously discussed, control interface 117 may also, or alternatively, interact with trigger 115 to prevent physical activation of trigger 115. In various embodiments, the safety mode may also be configured to prohibit deployment of a stimulus signal from signal generator 45, such as, for example, a local delivery.

The firing mode may be configured to enable deployment of one or more projectiles from deployment unit 112 in CEW 100. For example, and in accordance with various embodiments, in response to a user selecting the firing mode, control interface 117 may transmit a firing mode instruction to processing circuit 135. In response to receiving the firing mode instruction, processing circuit 135 may enable deployment of a projectile from deployment unit 112. In that regard, in response to trigger 115 being activated, processing circuit 135 may cause the deployment of one or more projectiles. Processing circuit 135 may enable deployment until a further instruction is received from control interface 117 (e.g., a safety mode instruction). As a further example, and in accordance with various embodiments, in response to a user selecting the firing mode, control interface 117 may also mechanically (or electronically) interact with trigger 115 of CEW 100 to enable activation of trigger 115.

In various embodiments, CEW 100 may comprise other modes operable into by control interface 117. For example, CEW 100 may comprise modes including a training mode, a manufacturing mode, a functional test mode, an update mode, a stealth mode, a virtual reality mode, and/or the like. In these modes, one or more features or components of CEW 100 may be enabled or disabled compared to the standard firing mode and/or safety mode. For example, in the training mode a provision of a stimulus signal may be disabled. As a further example, in the stealth mode audio and/or light components may be disabled. As a further example, in the virtual reality mode, signals for deploying cartridges and/or provisional of a stimulus signal may be disabled. As a further example, in the update mode, deployment features and other components may be disabled.

In various embodiments, light module 150 may be at least partially disposed within handle 110. Light module 150 may be disposed (e.g., positioned) in handle 110 proximate deployment end 114. Light module 150 may be disposed through an outer surface of handle 110. Light module 150 may be oriented in a direction at least partially aligned with deployment end 114 and/or deployment unit 112. Light module 150 may be in electrical communication with power supply 140. Light module 150 may receive power (e.g., electrical current) from power supply 140 to power electronic properties or components. Light module 150 may be in electrical and/or electronic communication with processing circuit 135. Processing circuit 135 may be configured to control operation of light module 150. Processing circuit 135 may be configured to control provision of power from power supply 140 to light module 150. In some embodiments, light module 150 may be in electrical, electronic, and/or mechanical communication with control interface 117 and/or trigger 115. In that regard, operation of control interface 117 and/or trigger 115 may activate (or cause activation of) light module 150. In other embodiments, processing circuit 135 may be configured to activate (or cause activation of) light module 150 responsive to operation of control interface 117 and/or trigger 115.

Light module 150 may be similar to, or have similar aspects and/or components with, any other light module, laser, laser sight, and/or the like discussed herein. Light module 150 may comprise any suitable or desired number of light modules. Light module 150 may comprise any suitable components capable of producing light. For example, light module 150 may comprise a flashlight, a light-emitting diode (LED), a strobe light, and/or any other similar light-emitting component. Light module 150 may also be configured to aid in accurately aligning deployment of projectiles from deployment unit 112 towards a target. For example, light module 150 may be configured to provide an aiming laser. Light module 150 may comprise any suitable laser-output component.

In some embodiments, light module 150 may be configured to provide a visual indication that handle 110, or components of handle 110, is receiving electrical power from power supply 140, that control interface 117 has been activated, that CEW 100 is ready to deploy projectiles, and/or the like.

In various embodiments, light module 150 may comprise a flashlight and a laser. The flashlight and/or the laser may be used to aid is aiming and or deployment CEW 100. For example, the flashlight may be configured to illuminate a target and/or environment proximate to and/or forward the CEW. The laser may be configured to provide a visual indication on a target depicting an expected deployment position of one or more projectiles from CEW 100.

In various embodiments, CEW 100 may comprise one or more user interfaces. A user interface may be configured to provide an output to the user of the CEW 100. A user interface may be located in any suitable location on or in handle 110. For example, a user interface may be coupled to an outer surface of handle 110, or extend at least partially through the outer surface of handle 110. The user interface may extend at least partially through the outer surface of handle 110 at a location viewable by the user during operation of CEW 100. A user interface may be electrically, mechanically, and/or electronically coupled to processing circuit 135. In various embodiments, in response to a user interface comprising electronic or electrical properties or components, the user interface may be electrically coupled to power supply 140. The user interface may receive power (e.g., electrical current) from power supply 140 to power the electronic properties or components.

Due to cost, weight, durability, and other issues, concerns, limitations, and/or the like, some CEWs may comprise a user interface with only basic output features. For example, a CEW may comprise a user interface only capable of outputting a light (e.g., a light-emitting component), such as one or more LEDs. In that respect, the user interface may not include components configured to receive an input, such as an audio capturing module (e.g., microphone) configured to receive an audio input, a visual display (e.g., touchscreen, etc.) configured to receive a manual input, and/or the like. Further, the user interface may not include components with more advanced features, such as an audio output module (e.g., audio speaker) configured to output audio, a haptic module configured to provide haptic feedback and/or output (e.g., a haptic motor, a haptic driver, a vibrating motor, an eccentric rotating mass (ERM) vibration motor, etc.), a visual display (e.g., touchscreen, LCD, etc.) configured to output a visual, and/or the like.

In that regard, and in accordance with various embodiments, CEW 100 may comprise a user interface configured as a light-emitting component, such as LED interface 160.

LED interface 160 may be at least partially disposed within handle 110. LED interface 160 may be disposed (e.g., positioned) in handle 110 proximate handle end 113. LED interface 160 may be disposed through an outer surface of handle 110. Light module 150 may be oriented in a direction at least partially aligned with a user operating CEW 100. LED interface 160 may be in electrical communication with power supply 140. LED interface 160 may receive power (e.g., electrical current) from power supply 140 to power light-emitting components of LED interface 160. LED interface 160 may be in electrical and/or electronic communication with processing circuit 135. Processing circuit 135 may be configured to control operation of LED interface 160. Processing circuit 135 may be configured to control provision of power from power supply 140 to LED interface 160. Controlling provision of power to LED interface 160 may control light-emitting characteristics of LED interface 160. In some embodiments, LED interface 160 may be in electrical, electronic, and/or mechanical communication with control interface 117 and/or trigger 115. In that regard, operation of control interface 117 and/or trigger 115 may activate (or cause activation of) LED interface 160. In other embodiments, processing circuit 135 may be configured to activate (or cause activation of) LED interface 160 responsive to operation of control interface 117 and/or trigger 115.

In various embodiments, LED interface 160 may be configured to provide an LED indication. An LED indication may comprise one or more emissions of light. An LED indication may be configured to provide a visual notice to a user of CEW 100. LED interface 160 may be configured to provide a plurality of LED indications. One or more LED indications of the plurality of LED indications may be provided based on different events. For example, LED interface 160 may be configured to provide a first LED indication, a second LED indication, a third LED indication, and/or a fourth LED indication. One or more of the LED indications may be different. The first LED indication may be provided during a software installation; the second LED indication may be provided responsive to a successful software installation; the third LED indication may be provided responsive to an unsuccessful software installation; the fourth LED indication may be provided responsive to an unsuccessful software installation causing corruption of CEW 100; and/or the like, as discussed further herein.

In various embodiments, LED interface 160 may comprise one or more LEDs 165. For example, in some embodiments LED interface 160 may comprise three LEDs (e.g., a first LED, a second LED, and a third LED). An LED 165 may comprise any suitable type of light-emitting device. An LED 165 may be configured to emit a white light (e.g., an uncolored light). An LED 165 may be configured to emit a light having a color. An LED 165 may be configured to emit a light having a plurality of different colors. For example, an LED 165 may comprise an RBG (i.e., red blue green) LED configured to output a white light, a red light, a blue light, a green light, and/or combinations thereof (e.g., yellow, purple, orange, teal, etc.).

In various embodiments, processing circuit 135 may be configured to control (e.g., activate, deactivate, etc.) one or more LEDs 165 of LED interface 160. For example, processing circuit 135 may collectively control all of LEDs 165 of LED interface 160 (e.g., control all of a first LED, a second LED, a third LED, etc.). Processing circuit 135 may individually control one or more LEDs 165 of LED interface 160 (e.g., control a first LED, control a second LED, control a third LED, control combinations thereof, etc.).

Processing circuit 135 may be configured to control one or more LEDs 165 of LED interface 160 based on a light emitting characteristic. The light emitting characteristic may define characteristics of emitting light from one or more LEDs 165 of LED interface 160. Processing circuit 135 may control emitting light from one or more LEDs 165 of LED interface 160 based on the light emitting characteristic. For example, a light emitting characteristic may define an emitting color (e.g., for one or more LEDs 165 of LED interface 160 capable of emitting lights in more than one color). A light emitting characteristic may define an emitting time. The emitting time may define a period of time that one or more LEDs 165 of LED interface 160 emit light (e.g., 5 seconds, 10 seconds, 20 seconds, 30 second, 1 minute, etc.). In various embodiments, the emitting time may be defined by a period of time control interface 117 is in an active mode (e.g., one or more LEDs 165 of LED interface 160 may emit light until control interface 117 is operated into a safety mode). In various embodiments, the emitting time may be defined by a period of time trigger 115 is operated (e.g., one or more LEDs 165 of LED interface 160 may emit light until trigger 115 is released).

A light emitting characteristic may define an emitting pattern. The emitting pattern may define or select one or more LEDs 165 of LED interface 160 to emit light. The emitting pattern may define how one or more LEDs 165 of LED interface 160 emit light. For example, the emitting pattern may define a continuous light emission, a strobing (e.g., non-continuous, etc.) light emission, an amplified light emission (e.g., emission slowly increases brightness, slowly decreases brightness, etc.), and/or the like. The emitting pattern may also define an emitting order. The emitting order may define an order (e.g., list) that one or more LEDs 165 of LED interface 160 emit light.

In various embodiments, instructions controlling LED interface 160 (e.g., visual output instructions, local instructions, etc.) may be stored in memory and executed by processing circuit 135. The instructions may include one or more light emitting characteristics. In various embodiments, instructions controlling LED interface 160 (e.g., visual output instructions, installation package instructions, etc.) may be provided by an installation package and executed by processing circuit 135. The instructions may include one or more light emitting characteristics. In various embodiments, one or more light emitting characteristics may also be defined by physical characteristics and/or firmware of one or more light emitting components of LED interface 160.

In various embodiments, a CEW may be configured to receive and install software. For example, a CEW may receive an installation package (e.g., installation file, data packet, distribution, application package, etc.) electronically. A CEW may receive an installation package via a wired connection, such as a wired connection to an electronic device, computing device, server, or the like. A CEW may receive an installation package via a wireless connection, such as via a network, a short-range communication, a long-range communication, or the like.

An installation package may include information needed for the CEW to successfully install or uninstall a software. For example, an installation package may include a set of files including the software and files needed to install or uninstall the software. The files needed to install or uninstall the software may include an application programming interface (API). The files needed to install or uninstall the software may include instructions executable by a processing circuit of the CEW. The instructions (e.g., installation instructions) may include file associations, services, custom actions, and/or the like. The installation package may also comprise identifying information (e.g., metadata, notes, tags, etc.) about the software, such as a software name, a software version, a software release date, and/or the like.

Installing the software may comprise any suitable installation process. Installing the software may include the CEW entering an update mode. Installing the software may include uninstalling software before installing the software. Installing the software may include decompiling or unpacking files, packages, and/or the like before installing the software. Installing the software may include restarting the CEW. The installation process may depend on the type of software being installed. The CEW may execute the installation package to install the software. The CEW may reboot and/or load into a bootloader before installing the software.

An installation package may be encrypted. For example, an installation package may be digitally signed. An installation package may be encrypted with asymmetric cryptography, and/or using any other suitable type of encryption disclosed herein. In some embodiments, an installation process may include verifying a digital signature of an installation package. An installation process may also include decrypting the installation package.

The software may comprise any suitable software configured for installation on a CEW. For example, the software may comprise system software, utility software, application software, and/or the like. The software may comprise firmware, driver software, and/or the like. The software may comprise new software (e.g., software not currently installed on the CEW) or may comprise an update to existing software (e.g., software currently installed on the CEW).

Typically, a CEW is powered on before beginning a software installation. In other embodiments, a CEW is powered on in response to beginning a software installation. To ensure that the software installation completes successfully (e.g., the software installs, the software is not corrupted, etc.), in some embodiments the CEW must remain powered on, uninterrupted, unoperated, and/or the like during the software installation. In CEWs having an LED interface without a more advanced user interface (e.g., no video output, no digital display output, no audio output, etc.), the CEW may provide a separate indication to a user of the CEW that the CEW is installing software.

For example, a CEW may provide an LED indication configured to notify the user of the CEW as to the status of the installation process. The CEW may provide a first LED indication configured to notify the user that the installation process has started, is pending, or the like. The CEW may provide a second LED indication configured to notify the user that the installation process has completed successfully. The CEW may provide a third LED indication configured to notify the user that the installation process has completed unsuccessfully. The CEW may provide a fourth LED indication configured to notify the user that the installation process has completed unsuccessfully and has corrupted software of the CEW. Each of the LED notifications may be different, and/or comprise different properties, features, and/or characteristics (e.g., light emitting characteristics).

As a further example, a CEW may disable and/or enable one or more CEW components to notify the user of the CEW as to the status of the installation process. The CEW may disable a light module of the CEW to visually notify the user that the installation process has started, is pending, or the like. The CEW may enable the light module of the CEW to visually notify the user that the installation process has completed successfully. The CEW may enable and adjust output of the light module of the CEW to visually notify the user that the installation process has completed unsuccessfully. The light module of the CEW may remain disabled to visually notify the user that the installation process has completed unsuccessfully and has corrupted software of the CEW.

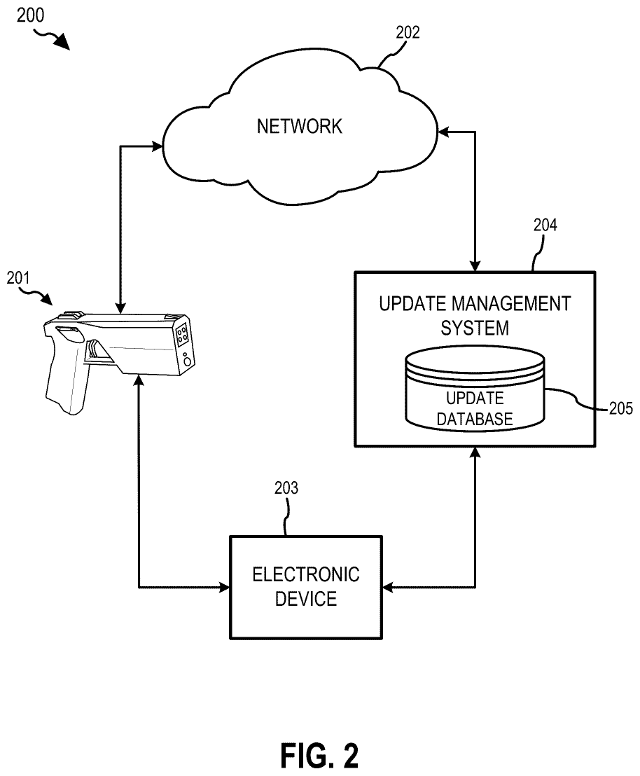

In various embodiments, and with reference to FIG. 2, a conducted electrical weapon (CEW) ccosystem 200 is disclosed. CEW ecosystem 200 may comprise one or more of a CEW 201, an electronic device 203, and/or an update management system 204. In some embodiments, one or more of CEW 201, electronic device 203, and/or update management system 204 may be in direct electronic communication with each other. For example, CEW 201 may be in direct communication with electronic device 203; electronic device 203 may be in direct communication with CEW 201 and/or update management system 204; and/or the like.

In various embodiments, network 202 may be configured to enable electronic communications between one or more systems or devices of CEW ecosystem 200. For example, network 202 may enable respective electronic communication between each of CEW 201, electronic device 203, and update management system 204. In that respect, network 202 may comprise any communication channel capable of enabling long-range communications or short-range communications. For example, network 202 may enable electronic communications through one or more communication channels such as a telephone network, a cellular network, an extranet, an intranet, the internet, a wireless communication, a wireless personal area network (WPAN), a local area network (LAN), a wide area network (WAN), a virtual private network (VPN), and/or the like.

In various embodiments, one or more of the communication channels enabling electronic communications in network 202 may be unsecure. Electronic communications disclosed herein via network 202 may utilize data encryption. Encryption may be performed by way of any of the techniques now available in the art or which may become available. Network communications may also incorporate SHA series cryptographic methods, elliptic-curve cryptography (e.g., ECC, ECDH, ECDSA, etc.), and/or other post-quantum cryptography algorithms under development. In various embodiments, electronic communications (and/or individual data in an electronic communication) may also be digitally signed, or may include any other security control.

For the sake of brevity, conventional data networking, application development, and other functional aspects of system may not be described in detail herein. Furthermore, the connecting lines shown in the various figures contained herein are intended to represent exemplary functional relationships and/or electronic communications between the various CEW ecosystem 200 components. Many alternative or additional functional relationships or electronic communications may be present in a practical system or ecosystem.

In various embodiments, CEW 201 may be similar to any other CEW disclosed herein (e.g., CEW 100, with brief reference to FIG. 1). For the sake of brevity, redundant characteristics or elements of a CEW described herein may be omitted in describing CEW 201 below. CEW 201 may be configured to deploy, or cause deployment of, one or more projectiles. CEW 201 may also be configured to transmit and/or receive data and/or instructions, as discussed further herein.

In various embodiments, electronic device 203 may comprise, or be in electronic communication with, a computing device such as a server, a computer-based system, a portable computer-based system (e.g., a laptop, a notebook, a hand held computer, a tablet, a personal digital assistant, etc.), a cellular phone, a smart phone (e.g., IPHONE®, ANDROID®, etc.), a wearable device (e.g., a smart watch, smart glasses, a body-worn camera, etc.), an internet of things (IoT) device, and/or any other device capable of transmitting and/or receiving data over a network.

Electronic device 203 may comprise one or more software and/or hardware components. For example, electronic device 203 may comprise hardware such as a processing unit, a communications unit, a memory unit, an input device, and/or an output device. Electronic device 203 may comprise software configured to manage and/or interact with the hardware components, such as, for example, an operating system, user interfaces, software applications, and/or the like.

Electronic device 203 may be configured to transmit and/or receive data, perform calculations on or regarding the data, transmit and/or receive instructions, and/or the like, as discussed further herein. In some embodiments, electronic device 203 may act as an intermediary device between CEW 201 and update management system 204. For example, electronic device 203 may receive data from CEW 201 and transmit data to update management system 204. Electronic device 203 may also receive data from update management system 204 and transmit the data to CEW 201.

In various embodiments, update management system 204 may be configured to receive, provide, manage, and/or store update data. The update data may comprise software updates, firmware updates, and/or the like. For example, the update data may comprise critical updates, definition updates, driver updates, feature updates, security updates, service packs, and/or the like. The update data may also comprise installation packages, as previously discussed herein. Update management system 204 may include at least one computing device in the form of a computer or processor, or a set of computers or processors, although other types of computing units or systems may be used, such as, for example, a processing circuit, a server, web server, pooled servers, or the like. Update management system 204 may comprise a database management system (DBMS) configured to define, manipulate, retrieve, and manage data in a database or data structure. Update management system 204 may comprise an update database 205 configured to store and maintain the update data. Update database 205 may comprise any suitable database, data structure, or the like capable of storing and maintaining data. Update database 205 may store and maintain the update data using any suitable process. Update management system 204 may be in electronic communication with one or more devices or components of CEW ecosystem 200.

In various embodiments, update management system 204 may be an evidence management system. An evidence management system receives, provides, manages, and/or stores evidence. An evidence management system may store evidence received by a responder agency (e.g., an agency associated with the emergency responder), a receiver agency (e.g., an agency associated with the emergency receiver), and/or the like. For example, in a practical application the evidence management system may store evidence received from a law enforcement agency. The evidence may include any type of data including text, audio, image, and/or video. The evidence may be stored on servers or databases (e.g., update database 205) and accessed via a network. An evidence management system may include a server to perform the functions of an evidence management system. The server may include one or more servers and/or computing devices. The server may control other electronic devices to perform the functions of an evidence management system. The server may include engines and data stores which operate to store and process data and metadata received from systems and devices in CEW ecosystem 200. In various embodiments, update management system 204 may comprise a cloud-based distributed evidence management system, such as, for example, AXON EVIDENCE® offered by Axon Enterprise, Inc.

In various embodiments, update management system 204 may be a compliance, workflow, evidence, and/or reporting system, such as, for example, AXON RECORDS® offered by Axon Enterprise, Inc.

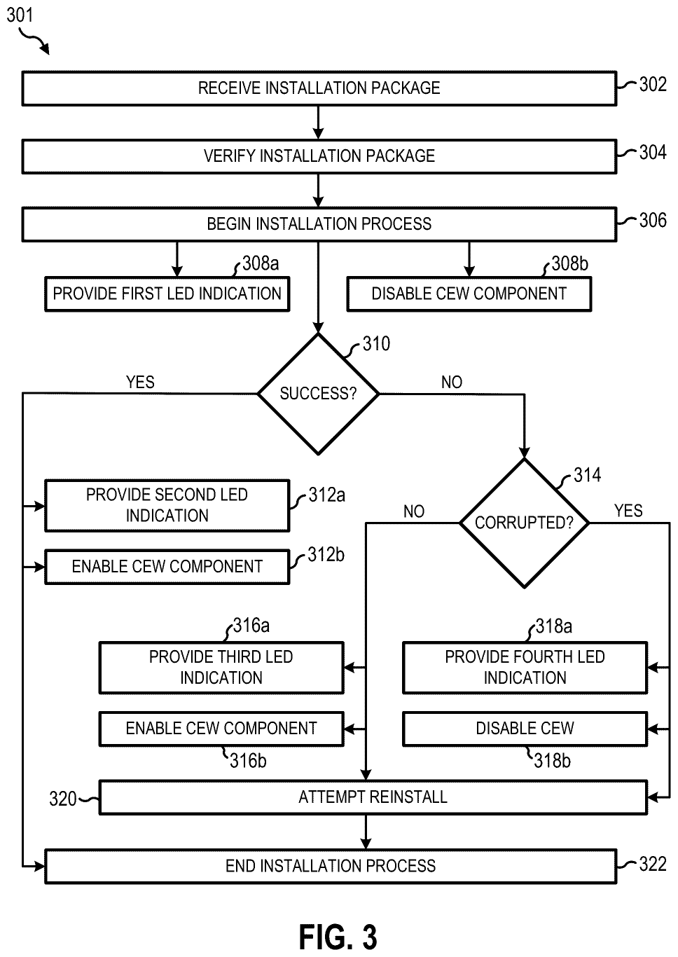

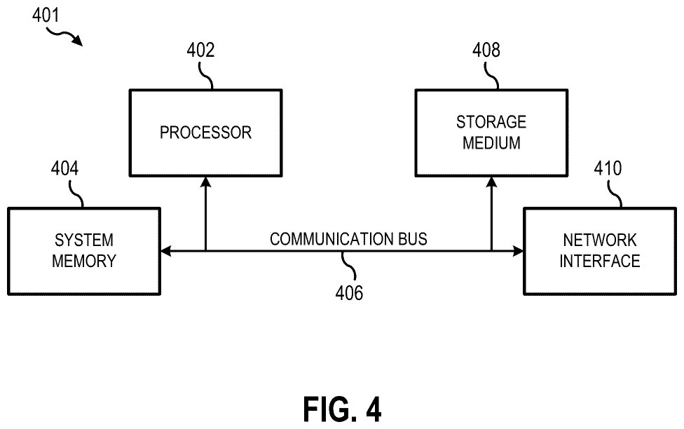

Referring now to FIG. 3, the process flows depicted are merely embodiments and are not intended to limit the scope of the disclosure. For example, the steps recited in any of the method or process descriptions may be executed in any order and are not limited to the order presented. As a further example, one or more steps recited in any of the method or process descriptions may be omitted. It will be appreciated that the following description makes appropriate references not only to the steps depicted in FIG. 3, but also to the various CEWs, devices, and systems as described above with reference to FIGS. 1 and 2, and below with reference to FIG. 4. Although the following makes reference to a CEW performing the steps depicted in FIG. 3, one or more of the steps in each process flow may be performed by components of the CEW (e.g., a processing circuit), a computer-based system, an electronic device, a server, and/or the like.

In various embodiments, a method 301 for providing indication of a software update in a CEW is disclosed. The CEW may comprise an LED indicator used to provide output, context, and/or the like to a user of the CEW. The LED indicator may comprise a plurality of LEDs, such as, for example, a first LED, a second LED, a third LED, and/or the like.

A CEW may receive power. For example, the CEW may receive power in response to having a battery (e.g., power supply) electrically coupled to the CEW. The CEW may receive power in response to interfacing with an electronic device through a wired connection. The CEW may receive power to one or more components of the CEW in response to a control interface of the CEW activating the CEW (e.g., operation of the control interface to an active mode).

In various embodiments, prior to receiving an installation package and/or beginning an installation process, the CEW may be operated into an update mode. For example, the CEW may be operated into the update mode based on operation of the control interface. As a further example, the CEW may be operated into the update mode in response to the CEW interfacing with an electronic device. The CEW may interface with the electronic device via a wired connection. The CEW may interface with the electronic device via a wireless connection. The electronic device may instruct the CEW to operate into the update mode.

The CEW may receive an installation package (step 302). The installation package may contain information needed for the CEW to install and/or uninstall a software. The CEW may receive the installation package from any suitable source. For example, the CEW may download the installation package from an update management system via a network. As a further example, the CEW may receive the installation package via a communication with an electronic device. In some embodiments, the installation package may be digitally signed and/or encrypted.

In some embodiments, the installation package may be transmitted and fully received before proceeding with an installation process. In some embodiments, the installation package may be received as data packets over time and the installation process may begin before all of the data packets are received. In that regard, the installation process may be concurrent (or at least partially overlap in time with) with receiving data packets of the installation package.

The CEW may verify the installation package (step 304). The CEW may verify the installation package using any suitable process. For example, the CEW may verify a digital signature of the installation package. In response to the installation package being encrypted, the CEW may decrypt the installation package. As a further example, the CEW may verify contents of the installation package. The CEW may determine whether the software is compatible with the CEW, including components of the CEW. The CEW may determine whether an installation of the software is needed. For example, the CEW may compare a software version number of installed software with a software version number associated with the software in the installation package. As a further example, the CEW may verify the installation package by decompiling, unpacking, and/or the like the installation package.

The CEW may begin an installation process (step 306). The CEW may begin the installation process using any suitable process. Although referred to as an “installation” process, the installation process may include an installation of software, an uninstallation of software, and/or an installation and an uninstallation of software. For example, the CEW may execute the files in the installation package needed for the CEW to install the software. A processing circuit of the CEW may execute instructions to begin installing the software. The processing circuit may begin installing the software in memory of the CEW. In some embodiments, a user may operate the CEW into an update mode before the CEW may begin the installation process.

The CEW may provide a first LED indication (step 308a). The CEW may provide the first LED indication (e.g., an installation indication) in response to beginning the installation process. The CEW may provide the first LED indication before beginning the installation process. The CEW may provide the first LED indication in after beginning the installation process. The first LED indication may be configured to provide notice to a user of the CEW that the CEW is undergoing an installation process. The processing circuit may control an LED interface of the CEW to provide the first LED indication. Controlling the LED interface may include selectively providing power to LEDs of the LED interface.

In various embodiments, the first LED indication may be based on instructions (e.g., installation package instructions) in the installation package. In that regard, the installation package may define the first LED indication. The processing circuit may execute the installation package instructions to cause the LED interface to provide the first LED indication. In various embodiments, the first LED indication may be based on instructions (e.g., local instructions) stored in memory of the CEW and/or the processing circuit. In that regard, the CEW may define the first LED indication. The processing circuit may execute the local instructions to cause the LED interface to provide the first LED indication.

In various embodiments, the instructions may provide one or more light emitting characteristics defining the first LED indication. The light emitting characteristics may define an emitting color, an emitting time, an emitting pattern, an emitting order, and/or the like. For example, and in accordance with various embodiments, light emitting characteristics defining the first LED indication may comprise an emitting color of the color green. In that regard, the processing circuit may control the LED interface (and/or one or more LEDs of the LED interface) to emit light in the color green. As a further example, and in accordance with various embodiments, light emitting characteristics defining the first LED indication may comprise an emitting pattern of an amplified light emission. In that regard, the processing circuit may control the LED interface (and/or one or more LEDs of the LED interface) to emit light as an amplified light emission.

In various embodiments, the first LED indication may comprise a static indication. The instructions may define the static indication. In that regard, the first LED indication may remain the same throughout the installation process, based on the light emitting characteristics (e.g., the first LED indication may be the same or similar throughout the installation process).

In various embodiments, the first LED indication may comprise a dynamic indication. The instructions may define the dynamic indication. In that regard, the first LED indication may change during the installation progress (e.g., properties of emitted light changes during the installation process), based on the light emitting characteristics. For example, the first LED indication may change based on the installation progress to visually depict the installation progress. An emitting pattern of the first LED indication may change based on the installation progress. An emitting color of the first LED indication may change based on the installation progress. Other light emitting characteristics of the first LED indication may change based on the installation progress.

For example, and in accordance with various embodiments, a LED interface may comprise three LEDs including a first LED, a second LED, and a third LED. One or more of the first LED, the second LED, and the third LED may emit light differently based on progress of the installation. For example, during a beginning of the installation process, the first LED may emit light while the second LED and the third LED do not emit light. The first LED may cmit light based on an emitting color of a green color. The first LED may emit light based on an emitting pattern of strobing or an amplified light emission. As the installation process progresses, the first LED may emit solid light and the second LED may emit light based on an emitting color of a green color and an emitting pattern of strobing or an amplified light emission. For example, in response to the installation process progressing past about 33% towards completion. As the installation process further progresses, the first LED and the second LED may emit solid light and the third LED may emit light based on an emitting color of a green color and an emitting pattern of strobing or an amplified light emission. For example, in response to the installation process progressing past about 66% towards completion. As the installation process further progresses, the first LED, the second LED, and the third LED may emit solid light. For example, in response to the installation process progressing near 100% completion.

The CEW may disable a CEW component (step 308b). The CEW may disable a CEW component in response to beginning the installation process. The CEW may disable a CEW component before beginning the installation process. The CEW may disable a CEW component after beginning the installation process. Disabling a CEW component may include removing power to (or selectively diverting power from) the CEW component. For example, a processing circuit may operate to remove power to the CEW component. In various embodiments, the CEW component to be disabled may be related to the software being installed. For example, the software installation may comprise firmware associated with the CEW component. The CEW component may be disabled so that the firmware may be successfully installed.

In various embodiments, the CEW component to be disabled may be unrelated to the software being installed. For example, the software may comprise firmware associated with a first CEW component and the disabled CEW component may be unrelated to the first CEW component. The CEW component to be disabled may be related to deployment capabilities of the CEW. For example, the CEW component to be disabled may comprise a deployment unit, a signal generator, a trigger, and/or the like. In that regard, the CEW may be unable to deploy projectiles, provide ignition signals, provide stimulus signals, and/or the like. The CEW component to be disabled may be related to light outputs of the CEW. For example, the CEW component to be disabled may comprise a light module. The CEW component to be disabled may comprise a flashlight and a laser. In that respect, disabling the CEW component may provide a further visual identifier to the user of the CEW that an installation process is taking place.

In various embodiments, the CEW component to be disabled may be based on instructions (e.g., installation package instructions) in the installation package. In that regard, the installation package may define the one or more CEW components to be disabled prior to or during the installation process. The processing circuit may execute the installation package instructions to cause the one or more CEW components to be disabled. In various embodiments, the CEW component to be disabled may be based on instructions (e.g., local instructions) stored in memory of the CEW and/or the processing circuit. In that regard, the CEW may define the one or more CEW components to be disabled. The processing circuit may execute the local instructions to cause the one or more CEW components to be disabled.

In various embodiments, the CEW may perform steps 308a and 308b in any suitable order. For example, the CEW may perform step 308a together with step 308b (e.g., at a same time, at a near time, etc.). The CEW may perform step 308a before step 308b. The CEW may perform step 308b before step 308a.

The CEW may determine whether the installation process was successful (step 310). The CEW may determine whether the installation process was successful using any suitable technique. For example, upon completion of executing instructions provided by an installation package, the CEW may determine whether one or more components of the CEW are properly functioning. The CEW may also run software tests to determine whether software and/or hardware components are properly functioning. The CEW may reboot to determine whether the CEW restarts successfully (e.g., successfully loads software). A “successful” installation process may refer to an installation of software completed without error. In some embodiments, a “successful” installation process may refer to an installation of software completed without a critical error. An “unsuccessful” installation process may refer to an installation of software that failed or did not complete. In some embodiments, an “unsuccessful” installation process may refer to an installation of software that completed but with a critical error.

In response to the installation process being successful, the CEW may provide a second LED indication (step 312a). The second LED indication (e.g., a successful indication) may be configured to provide notice to a user of the CEW that the CEW successfully completed a software installation. The processing circuit may control an LED interface of the CEW to provide the second LED indication. Controlling the LED interface may include selectively providing power to LEDs of the LED interface.

In various embodiments, the second LED indication may be based on instructions (e.g., installation package instructions) in the installation package. In that regard, the installation package may define the second LED indication. The processing circuit may execute the installation package instructions to cause the LED interface to provide the second LED indication. In various embodiments, the second LED indication may be based on instructions (e.g., local instructions) stored in memory of the CEW and/or the processing circuit. In that regard, the CEW may define the second LED indication. The processing circuit may execute the local instructions to cause the LED interface to provide the second LED indication.

In various embodiments, the instructions may provide one or more light emitting characteristics defining the second LED indication. The light emitting characteristics may define an emitting color, an emitting time, an emitting pattern, an emitting order, and/or the like, as previously discussed herein. In various embodiments, the second LED indication may comprise a static indication, as previously discussed herein.

In various embodiments, the second LED indication may be different from the first LED indication. The second LED indication may be different in whole or in part to the first LED indication. For example, the second LED indication may not share any light emitting characteristics with the first LED indication. As a further example, the second LED indication may share one or more light emitting characteristics with the first LED indication, but differ with one or more other light emitting characteristics.

In various embodiments, the second LED indication may provide a same emitting color as the first LED indication. For example, the second LED indication and the first LED indication may provide an emitting color of green. The second LED indication may comprise a static indication while the first LED indication comprises a dynamic indication. The second LED indication may comprise a different emitting pattern, emitting order, and/or the like compared to the first LED indication.

In response to the installation process being successful, the CEW may enable a CEW component (step 312b). The CEW may enable the one or more CEW components disabled in step 308b. The CEW may enable the one or more CEW components using any suitable process. The CEW may enable the one or more CEW components in any suitable order. For example, the processing circuit of the CEW may control and provide power to the one or more CEW components. The CEW may restart and power may be provided to the one or more CEW components subsequent to the restart.

In various embodiments where the disabled CEW components comprised a light module, or a flashlight and/or a laser, enabling the CEW components may provide a further visual identifier to the user of the CEW that an installation process was completed successfully. In some embodiments, enabling the light module, or the flashlight and/or the laser, may include enabling the components to provide a pattern light output (e.g., blinking the lights, flashing the lights, etc.). The pattern light output may provide a further visual identifier to the user of the CEW that an installation process was completed successfully.

In various embodiments, the CEW may perform steps 312a and 312b in any suitable order. For example, the CEW may perform step 312a together with step 312b (e.g., at a same time, at a near time, etc.). The CEW may perform step 312a before step 312b. The CEW may perform step 312b before step 312a.

In response to the installation process being unsuccessful, the CEW may determine whether the failed installation corrupted the CEW (step 314). A software installation may be unsuccessful due to a variety of events, including a faulty installation package, interruption to the CEW during the installation, and/or the like. In response to an unsuccessful installation, a CEW may attempt to restart, rollback the unsuccessful installation, and/or the like. A “corrupted” CEW may refer to an unsuccessful installation causing repeated software failures in the CEW. The repeated software failures may continue regardless of a restart, rollback, and/or the like. A CEW may detect whether the failed installation corrupted the CEW using any suitable process. For example, a corrupted CEW may comprise software that becomes unusable, unreadable, and/or the like. A corrupted CEW may comprise software that is unable to control or operate one or more CEW components. A corrupted CEW may comprise software that creates or encounters errors when executing. A corrupted CEW may comprise software that is unable to execute programs or instructions. A corrupted CEW may comprise software that is unable to read write, store, transmit, and/or process data.

For example, the CEW may encounter an unsuccessful software installation, but one that did not corrupt the CEW (e.g., a failed software installation). For example, a user interruption may lead to an unsuccessful software installation, a corrupted installation package may lead to an unsuccessful software installation, a delayed or interrupted transfer of data packets of an installation package may lead to an unsuccessful software installation, a timed-out installation may lead to an unsuccessful software installation (e.g., installation takes longer than a defined installation time), and/or the like. The CEW may determine an unsuccessful software installation using any suitable process. The CEW may restart, rollback the unsuccessful installation, and/or the like. The CEW may also request a fresh, new installation package and/or may redownload or re-receive the installation package.

In response to the CEW not being corrupted during the unsuccessful installation, the CEW may provide a third LED indication (step 316a). The third LED indication (e.g., an unsuccessful indication) may be configured to provide notice to a user of the CEW that the CEW unsuccessfully completed a software installation. The processing circuit may control an LED interface of the CEW to provide the third LED indication. Controlling the LED interface may include selectively providing power to LEDs of the LED interface.

In various embodiments, the third LED indication may be based on instructions (e.g., installation package instructions) in the installation package. In that regard, the installation package may define the third LED indication. The processing circuit may execute the installation package instructions to cause the LED interface to provide the third LED indication. In various embodiments, the third LED indication may be based on instructions (e.g., local instructions) stored in memory of the CEW and/or the processing circuit. In that regard, the CEW may define the third LED indication. The processing circuit may execute the local instructions to cause the LED interface to provide the third LED indication.

In various embodiments, the instructions may provide one or more light emitting characteristics defining the third LED indication. The light emitting characteristics may define an emitting color, an emitting time, an emitting pattern, an emitting order, and/or the like, as previously discussed herein. In various embodiments, the third LED indication may comprise a static indication, as previously discussed herein.

In various embodiments, the third LED indication may be different from the first LED indication and/or the second LED indication. The third LED indication may be different in whole or in part to the first LED indication and/or the second LED indication. For example, the third LED indication may not share any light emitting characteristics with the first LED indication and/or the second LED indication. As a further example, the third LED indication may share one or more light emitting characteristics with the first LED indication and/or the second LED indication.

In various embodiments, the third LED indication may provide a different emitting color from the first LED indication and/or the second LED indication. For example, the third LED indication may provide an emitting color of yellow or red while the first LED indication and/or the second LED indication provide an emitting color of green. The third LED indication may comprise a static indication while the first LED indication comprises a dynamic indication. The third LED indication may comprise a different emitting pattern, emitting order, and/or the like compared to the first LED indication and/or the second LED indication.

In response to the CEW not being corrupted during the unsuccessful installation, the CEW may enable a CEW component (step 316b). The CEW may enable the one or more CEW components disabled in step 308b. The CEW may enable the one or more CEW components using any suitable process. The CEW may enable the one or more CEW components in any suitable order. For example, the processing circuit of the CEW may control and provide power to the one or more CEW components. The CEW may restart and power may be provided to the one or more CEW components subsequent to the restart.

In various embodiments where the disabled CEW components comprised a light module, or a flashlight and/or a laser, enabling the CEW components may provide a further visual identifier to the user of the CEW that an installation process was completed unsuccessfully. In some embodiments, enabling the light module, or the flashlight and/or the laser, may include enabling the components to provide a pattern light output (e.g., blinking the lights, flashing the lights, etc.). The pattern light output may provide a further visual identifier to the user of the CEW that an installation process was completed unsuccessfully. In some embodiments, the pattern light output provided in step 316b (e.g., an unsuccessful pattern light output) may be different from the pattern light output provided in step 312b (e.g., a successful pattern light output).

In various embodiments, the CEW may perform steps 316a and 316b in any suitable order. For example, the CEW may perform step 316a together with step 316b (e.g., at a same time, at a near time, etc.). The CEW may perform step 316a before step 316b. The CEW may perform step 316b before step 316a.

In response to the CEW being corrupted during the unsuccessful installation, the CEW may provide a fourth LED indication (step 318a). The fourth LED indication (e.g., a corrupted indication) may be configured to provide notice to a user of the CEW that the CEW unsuccessfully completed a software installation and the CEW is now corrupted. The processing circuit may control an LED interface of the CEW to provide the fourth LED indication. Controlling the LED interface may include selectively providing power to LEDs of the LED interface.

In various embodiments, the fourth LED indication may be based on instructions (e.g., installation package instructions) in the installation package. In that regard, the installation package may define the fourth LED indication. The processing circuit may execute the installation package instructions to cause the LED interface to provide the fourth LED indication. In various embodiments, the fourth LED indication may be based on instructions (e.g., local instructions) stored in memory of the CEW and/or the processing circuit. In that regard, the CEW may define the fourth LED indication. The processing circuit may execute the local instructions to cause the LED interface to provide the fourth LED indication.

In various embodiments, the instructions may provide one or more light emitting characteristics defining the fourth LED indication. The light emitting characteristics may define an emitting color, an emitting time, an emitting pattern, an emitting order, and/or the like, as previously discussed herein. In various embodiments, the fourth LED indication may comprise a static indication, as previously discussed herein.

In various embodiments, the fourth LED indication may be different from the first LED indication, the second LED indication, and/or the third LED indication. The fourth LED indication may be different in whole or in part to the first LED indication, the second LED indication, and/or the third LED indication. For example, the fourth LED indication may not share any light emitting characteristics with the first LED indication, the second LED indication, and/or the third LED indication. As a further example, the fourth LED indication may share one or more light emitting characteristics with the first LED indication, the second LED indication, and/or the third LED indication.

In various embodiments, the fourth LED indication may provide a different emitting color from the first LED indication, the second LED indication, and/or the third LED indication. For example, the fourth LED indication may provide an emitting color of red while the first LED indication and/or the second LED indication provide an emitting color of green and the third LED indication provides an emitting color of yellow. The fourth LED indication may comprise a static indication while the first LED indication comprises a dynamic indication. The fourth LED indication may comprise a different emitting pattern, emitting order, and/or the like compared to the first LED indication, the second LED indication, and/or the third LED indication.

In response to the CEW being corrupted during the unsuccessful installation, the CEW may disable the CEW (step 318b). The CEW may disable itself using any suitable process. Disabling a CEW may include placing a tag, note, or the like in memory. Disabling a CEW may include preventing deployment from the CEW. Disabling a CEW may include disabling additional CEW components. The CEW may disable the one or more CEW components in any suitable order. For example, the processing circuit of the CEW may control and remove power to the one or more CEW components.

In various embodiments, the CEW may perform steps 318a and 318b in any suitable order. For example, the CEW may perform step 318a together with step 318b (e.g., at a same time, at a near time, etc.). The CEW may perform step 318a before step 318b. The CEW may perform step 318b before step 318a.

In various embodiments, in response to the installation process being unsuccessful, the CEW may attempt to reinstall the installation package (step 320). The CEW may attempt to reinstall the installation package using any suitable technique. In some embodiments, the CEW may attempt a clean install wherein a previous version of the relevant software is uninstalled, deleted, and/or removed prior to attempting to reinstall the installation package. In some embodiments, the CEW may redownload or request re-transmission of an installation package. In some embodiments, the CEW may attempt to reinstall the installation package similar to the initial installation process of step 306. In that regard, the CEW may repeat and perform steps 306-318b based on the installation process.

In various embodiments, the CEW may end the installation process (step 322). In response to the installation process ending, the CEW may power down. For example, the CEW may automatically power down. As a further example, a user of the CEW may operate a control interface to a safety position to power down the CEW.

In various embodiments, and with reference to FIG. 4, an exemplary computer-based system 401 is disclosed. Computer-based system 401 may be appropriate for use in accordance with embodiments of the present disclosure. The accompanying description of computer-based system 401 may be applicable to servers, personal computers, mobile phones, smart phones, tablet computers, embedded computing devices, and other currently available or yet-to-be-developed devices that may be used in accordance with embodiments of the present disclosure.

Computer-based system 401 may include a processor 402 and a system memory 404 connected by a communication bus 406. Depending on the exact configuration and type of computer-based system, system memory 404 may be volatile or nonvolatile memory, such as read only memory (“ROM”), random access memory (“RAM”), EEPROM, flash memory, or other memory technology. Those of ordinary skill in the art and others will recognize that system memory 404 typically stores data and/or program modules that are immediately accessible to and/or currently being operated on by processor 402. In this regard, processor 402 may serve as a computational center of computer-based system 401 by supporting the execution of instructions. Processor 402 may comprise one or more processing units, as discussed further herein. System memory 404 may comprise one or more memory units, as discussed further herein.

Computer-based system 401 may include a network interface 410 comprising one or more components for communicating with other devices and systems over a network. Embodiments of the present disclosure may access basic services that utilize network interface 410 to perform communications using common network protocols. Network interface 410 may comprise a communications unit, as discussed further herein.

Computer-based system 401 may also include a storage medium 408. However, services may be accessed using a computer-based system that does not include means for persisting data to a local storage medium. Therefore, storage medium 408 depicted in FIG. 4 is optional. Storage medium 408 may be volatile or nonvolatile, removable or nonremovable, and implemented using any technology capable of storing information such as, but not limited to, a hard drive, solid state drive, CD-ROM, DVD, or other disk storage, magnetic tape, magnetic disk storage, and/or the like. Storage medium 408 may include one or more memory units, as discussed further herein.

As used herein, the term “computer-readable medium” includes volatile and nonvolatile and removable and nonremovable media implemented in any method or technology capable of storing information, such as computer-readable instructions, data structures, program modules, or other data. In this regard, system memory 404 and storage medium 408 depicted in FIG. 4 are examples of computer-readable media.

For ease of illustration and because it is not important for an understanding of the claimed subject matter, FIG. 4 does not show some of the typical components of many computer-based systems. In this regard, computer-based system 401 may include input devices, such as a keyboard, keypad, mouse, trackball, microphone, video camera, touchpad, touchscreen, electronic pen, stylus, and/or any other input device described herein. Such input devices may be coupled to computer-based system 401 by wired or wireless connections including RF, infrared, serial, parallel, BLUETOOTH®, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computer-based system 401 (e.g., a client device), or can be integral components of computer-based system 401. In some embodiments, multiple input devices may be combined into a single, multifunction input device (e.g., a video camera with an integrated microphone).

Computer-based system 401 may also include output devices such as a display, speakers, printer, and/or any other output device described herein. The output devices may include video output devices such as a display or touchscreen. The output devices also may include audio output devices such as external speakers or earphones. The output devices can be separate from and communicatively coupled to computer-based system 401, or can be integral components of computer-based system 401. Input functionality and output functionality may be integrated into the same input/output device (e.g., a touchscreen). Any suitable input device, output device, or combined input/output device either currently known or developed in the future may be used with described systems.

In various embodiments, a “processing unit” as described herein may comprise any suitable hardware and/or software-based processing component. For example, a processing unit may comprise one or more of a processing circuit, a processor, an application specific integrated circuit (ASIC), a controller, a microcontroller, a microprocessor, a programmable logic device, logic circuitry, and/or the like.

In various embodiments, a “communications unit” as described herein may comprise any suitable hardware and/or software components capable of enabling the transmission and/or reception of data. A communications unit may enable electronic communications between devices and systems. A communications unit may enable communications over a network. Examples of a communications unit may include a modem, a network interface (such as an Ethernet card), a communications port, etc. Data may be transferred via a communications unit in the form of signals which may be electronic, electromagnetic, optical, or other signals capable of being transmitted or received by a communications unit. A communications unit may be configured to communicate via any wired or wireless protocol such as a CAN bus protocol, an Ethernet physical layer protocol (e.g., those using 10BASE-T, 100BASE-T, 1000BASE-T, etc.), an IEEE 1394 interface (e.g., Fire Wire), Integrated Services for Digital Network (ISDN), a digital subscriber line (DSL), an 402.11a/b/g/n/ac signal (e.g., Wi-Fi), a wireless communications protocol using short wavelength UHF radio waves and defined at least in part by IEEE 402.15.1 (e.g., the BLUETOOTH® protocol maintained by Bluetooth Special Interest Group), a wireless communications protocol defined at least in part by IEEE 402.15.4 (e.g., the ZigBee® protocol maintained by the ZigBee alliance), a cellular protocol, an infrared protocol, an optical protocol, or any other protocol capable of transmitting information via a wired or wireless connection.

Two or more of the system components may be in electronic communication via a network. As used herein, the term “network” may further include any cloud, cloud computing system, or electronic communications system or method that incorporates hardware and/or software components. Communication amongst the devices and systems over a network may be accomplished through any suitable communication channel, such as, for example, a telephone network, an extranet, an intranet, the internet, a wireless communication, local area network (LAN), wide area network (WAN), virtual private network (VPN), and/or the like.

Electronic communications between the systems and devices may be unsecure. A network may be unsecure. Electronic communications disclosed herein may utilize data encryption. Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

In various embodiments, a “memory” or “memory unit” as discussed herein may comprise any hardware, software, and/or database component capable of storing and maintaining data. For example, a memory unit may comprise a database, data structure, memory component, or the like. A memory unit may comprise any suitable non-transitory memory known in the art, such as, an internal memory (e.g., random access memory (RAM), read-only memory (ROM), solid state drive (SSD), etc.), removable memory (e.g., an SD card, an xD card, a CompactFlash card, etc.), or the like.

Any database discussed herein may include relational, hierarchical, graphical, distributed ledger, blockchain, object-oriented structure, and/or any other database configurations, unless otherwise specified. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Moreover, a database may be organized in any suitable manner, for example, as data tables or lookup tables. Each record stored in a database may be a single file, a series of files, a linked series of data fields, and/or any other data structure or schema.

Any database, system, device, server, or other components of the system described herein may consist of any combination thereof at a single location or at multiple locations. For example, any database described herein may comprise a single database or a plurality of databases (virtual partitions or physically distinct). Each database or system may include any of various suitable security features, such as firewalls, access codes, encryption, decryption, compression, decompression, and/or the like.

In various embodiments, an “input device” as discussed herein may comprise hardware and/or software used to provide data, inputs, control signals, and the like to a computer-based system, software application, etc. For example, an input device may include a pointing device (e.g., mouse, joystick, pointer, etc.), a keyboard (e.g., virtual or physical), a touchpad or touchscreen interface, a video input device (e.g., camera, scanner, multi-camera system, etc.), a virtual reality system, an audio input device (e.g., microphone, digital musical instrument, etc.), a biometric input device (e.g., fingerprint scanner, iris scanner, etc.), a composite device (e.g., a device having a plurality of different forms of input), and/or any other input device.

In various embodiments, an “output device” as discussed herein may comprise hardware and/or software configured to convert information into a human-accessible form, for display, projection, or physical reproduction. For example, an output device may include a display device (e.g., monitor, monochrome display, colored display, CRT, LCD, LED, projector, video card, etc.), an audio output device (e.g., speaker, headphones, sound card, etc.), a location services system (e.g., global positioning system (GPS), etc.), a printer (e.g., dot matrix printer, inkjet printer, laser printer, 3D printer, wide-format printer, etc.), a braille reader, a composite device (e.g., a device having a plurality of different forms of output), and/or any other output device.

In various embodiments, a method is disclosed. The method may be performed by a conducted electrical weapon (CEW). The method may comprise one or more steps including: receiving an installation package, wherein the installation package comprises instructions for installing a software; executing the instructions to begin installing the software in the installation package; providing, via an LED interface, a first LED indication configured to provide a first visual notice that the software is installing; and disabling a light module, wherein the disabling the light module is configured to provide a second visual notice that the software is installing.

In various embodiments of the above method, the software may comprise firmware, and the firmware may be unrelated to the light module. The first LED indication may comprise a static indication. The first LED indication may comprise a dynamic indication based on a status of the software being installed. The step of providing the first LED indication may be based on the instructions from the installation package. The step of providing the first LED indication may be based on local instructions stored in memory of the CEW. The steps may further comprise determining whether the software was successfully installed.

In various embodiments of the above method, in response to the software being successfully installed, the steps may further comprise: providing, via the LED interface, a second LED indication configured to provide a third visual notice that the software was successfully installed; and enabling the light module, wherein the enabling the light module is configured to provide a fourth visual notice that the software was successfully installed. The second LED indication may be different from the first LED indication.

In various embodiments of the above method, in response to the software being unsuccessfully installed, the steps may further comprise: providing, via the LED interface, a third LED indication configured to provide a fifth visual notice that the software was unsuccessfully installed; and enabling the light module, wherein the enabling the light module is configured to provide a sixth visual notice that the software was unsuccessfully installed. The third LED indication may be different from the first LED indication.

In various embodiments of the above method, in response to the software being unsuccessfully installed, the steps may further comprise: determining whether the software being unsuccessfully installed corrupted the CEW; and providing, via the LED interface, a fourth LED indication configured to provide a seventh visual notice that the software was unsuccessfully installed and the CEW was corrupted. The fourth LED indication may be different from the first LED indication. The steps may further comprise disabling, in response to the CEW being corrupted, an additional CEW component.

In various embodiments, a handle for a conducted electrical weapon is disclosed. The handle may comprise a processing circuit; an LED interface configured to provide a plurality of LED indications; a light module configured to provide a light output; and a tangible, non-transitory memory configured to communicate with the processing circuit. The tangible, non-transitory memory may comprise instructions stored thereon that, in response to execution by the processing circuit, cause the processing circuit to perform operations comprising: receiving an installation package, wherein the installation package comprises instructions for installing a software; executing the instructions to begin installing the software in the installation package; providing, via the LED interface, a first LED indication of the plurality of LED indications, wherein the first LED indication is configured to provide a first visual notice that the software is installing; and disabling the light module to cease providing the light output, wherein the disabling the light module is configured to provide a second visual notice that the software is installing.

In various embodiments of the above handle, the light module may comprise a flashlight and a laser, and disabling the light module may further comprise disabling the flashlight and disabling the laser. The plurality of LED indications may further comprise a second LED indication configured to provide a third visual notice that the software has successfully installed, a third LED indication may be configured to provide a fourth visual notice that the software has unsuccessfully installed, and a fourth LED indication may be configured to provide a fifth visual notice that the software has unsuccessfully installed and corrupted the conducted electrical weapon. Each of the first LED indication, the second LED indication, the third LED indication, and the fourth LED indication may be different. The first LED indication may comprise a dynamic indication, and the second LED indication, the third LED indication, and the fourth LED indication may each comprise a static indication. The handle may further comprise a body having a handle end opposite a deployment end, the light module may be positioned at the deployment end, and the LED interface may be positioned at the handle end.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosure is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Furthermore, no element, component, or method step in the present disclosure is intended to be dedicated to the public regardless of whether the element, component, or method step is explicitly recited in the claims. No claim element is intended to invoke 35 U.S.C. 112 (f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
receiving, by a conducted electrical weapon (“CEW”), an installation package, wherein the installation package comprises instructions for installing a software;
executing, by the CEW, the instructions to begin installing the software in the installation package;
providing, by the CEW and via an LED interface, a first LED indication configured to provide a first visual notice that the software is installing; and
disabling, by the CEW, a light module, wherein the disabling the light module is configured to provide a second visual notice that the software is installing.

2. The method of claim 1, wherein the software comprises firmware, and wherein the firmware is unrelated to the light module.

3. The method of claim 1, wherein the first LED indication comprises a static indication.

4. The method of claim 1, wherein the first LED indication comprises a dynamic indication based on a status of the software being installed.

5. The method of claim 1, wherein the providing the first LED indication is based on the instructions from the installation package.

6. The method of claim 1, wherein the providing the first LED indication is based on local instructions stored in memory of the CEW.

7. The method of claim 1, further comprising determining, by the CEW, whether the software was successfully installed.

8. The method of claim 7, wherein in response to the software being successfully installed, further comprising:
providing, by the CEW and via the LED interface, a second LED indication configured to provide a third visual notice that the software was successfully installed; and
enabling, by the CEW, the light module, wherein the enabling the light module is configured to provide a fourth visual notice that the software was successfully installed.

9. The method of claim 8, wherein the second LED indication is different from the first LED indication.

10. The method of claim 7, wherein in response to the software being unsuccessfully installed, further comprising:
providing, by the CEW and via the LED interface, a third LED indication configured to provide a fifth visual notice that the software was unsuccessfully installed; and
enabling, by the CEW, the light module, wherein the enabling the light module is configured to provide a sixth visual notice that the software was unsuccessfully installed.

11. The method of claim 10, wherein the third LED indication is different from the first LED indication.

12. The method of claim 7, wherein in response to the software being unsuccessfully installed, further comprising:
determining, by the CEW, whether the software being unsuccessfully installed corrupted the CEW; and
providing, by the CEW and via the LED interface, a fourth LED indication configured to provide a seventh visual notice that the software was unsuccessfully installed and the CEW was corrupted.

13. The method of claim 12, wherein the fourth LED indication is different from the first LED indication.

14. The method of claim 12, further comprising disabling, by the CEW and in response to the CEW being corrupted, an additional CEW component.

15. A handle for a conducted electrical weapon comprising:
a processing circuit;
an LED interface configured to provide a plurality of LED indications;
a light module configured to provide a light output; and
a tangible, non-transitory memory configured to communicate with the processing circuit, wherein the tangible, non-transitory memory comprises instructions stored thereon that, in response to execution by the processing circuit, cause the processing circuit to perform operations comprising:
receiving an installation package, wherein the installation package comprises instructions for installing a software;
executing the instructions to begin installing the software in the installation package;
providing, via the LED interface, a first LED indication of the plurality of LED indications, wherein the first LED indication is configured to provide a first visual notice that the software is installing; and
disabling the light module to cease providing the light output, wherein the disabling the light module is configured to provide a second visual notice that the software is installing.

16. The handle of claim 15, wherein the light module comprises a flashlight and a laser, and wherein disabling the light module further comprises disabling the flashlight and disabling the laser.

17. The handle of claim 15, wherein the plurality of LED indications further comprises a second LED indication configured to provide a third visual notice that the software has successfully installed, a third LED indication configured to provide a fourth visual notice that the software has unsuccessfully installed, and a fourth LED indication configured to provide a fifth visual notice that the software has unsuccessfully installed and corrupted the conducted electrical weapon.

18. The handle of claim 17, wherein each of the first LED indication, the second LED indication, the third LED indication, and the fourth LED indication are different.

19. The handle of claim 17, wherein the first LED indication comprises a dynamic indication, and wherein the second LED indication, the third LED indication, and the fourth LED indication each comprise a static indication.

20. The handle of claim 15, further comprising a body having a handle end opposite a deployment end, wherein the light module is positioned at the deployment end, and wherein the LED interface is positioned at the handle end.
